(19) United States
(12) Patent Application Publication
(10) Pub. No.: US 2016/0222235 A1
(43) Pub. Date: Aug. 4, 2016

(54) NON-AQUEOUS INK JET INK COMPOSITION

(71) Applicant: Seiko Epson Corporation, Tokyo (JP)

(72) Inventors: Keiji IIDA, Chikuhoku (JP); Kenichiro KUBOTA, Matsumoto (JP); Jun ITO, Shimosuwa (JP); Naoki KOIKE, Matsumoto (JP); Makoto NAGASE, Shiojiri (JP)

(21) Appl. No.: 15/013,114

(22) Filed: Feb. 2, 2016

(30) Foreign Application Priority Data
Feb. 3, 2015 (JP) 2015-019142

(51) Int. Cl. C09D 11/322; C09D 11/106; C09D 11/36

(52) U.S. Cl. CPC C09D 11/322; C09D 11/36; C09D 11/106; C08K 5/3447

(57) ABSTRACT

A non-aqueous ink jet ink composition contains C.I. Pigment Orange 43 as a pigment and one or more kinds of compounds represented by the following general formula (1) as a solvent and the content of water contained in the ink composition is 0.1% by mass or more and 2% by mass or less,

R¹O—(R²O)ₘ—R³ (1).

In general formula (1), R¹ and R³ each independently represent hydrogen or an alkyl group in which the number of carbon atoms is 1 or more and 4 or less. At least one of R¹ and R³ is an alkyl group in which the number of carbon atoms is 1 or more and 4 or less. R² represents an alkylene group having 2 or 3 carbon atoms. m represents an integer of 2 or 3.

### BACKGROUND

1. Technical Field

The present invention relates to a non-aqueous ink jet ink composition.

2. Related Art

An ink jet recording apparatus is known which records images and characters by discharging minute ink liquid droplets from a nozzle hole of a recording head to cause the ink liquid droplets to adhere to a recording medium. As ink for use in such recording, an ink jet ink composition containing various components, such as a coloring material, a surfactant, water, and an organic solvent, is known, for example. With respect to the ink jet ink composition, a development of a non-aqueous ink jet ink composition which does not substantially contain water has also been performed.

Such a non-aqueous ink composition has good adaptability to a vinyl chloride-based recording medium, and is used for recording for so-called signage applications such as outdoor signboards, in many cases, for example. However, when the non-aqueous ink jet ink composition is used for signage applications, the weatherability of recorded matter has been insufficient in some cases. More specifically, the recorded matter for signage applications is used in an outdoor environment exposed to rain, sunlight, and the like in many cases, and thus the recorded matter has been required to have weatherability higher than weatherability for indoor use.

On the other hand, by providing an orange ink (spot color ink) in addition to color ink, such as a cyan ink, a magenta ink, a yellow ink, and a black ink, color reproduction with a wide gamut can be achieved but it has been found that the weatherability of an orange ink pigment is inferior to that of other inks. Then, from the viewpoint of increasing the weatherability of the orange ink, an aqueous ink composition, a non-aqueous ink composition, and an ink set containing a C.I. Pigment Orange 43 (hereinafter also simply referred to as “PO43”) which is relatively excellent in weatherability as the orange ink pigment has been proposed (for example, JP-A-2009-173853, JPA-2004-70048, and JP-A-2011-89043).

However, it has been clarified that, when the non-aqueous ink composition containing the PO43 is stored for a long period of time, foreign substances are generated in the ink. When foreign substances are generated in ink, a problem that an ink discharge nozzle of an ink jet printer is clogged to cause missing dots, for example, may arise.

### SUMMARY

An advantage of some aspects of the invention is to provide a non-aqueous ink jet ink composition capable of forming an image excellent in weatherability and printed image quality and also suppressing the generation of foreign substances in ink to achieve excellent long-term storage stability thereof.

Another advantage of some aspects of the invention is to provide a non-aqueous ink jet ink composition capable of forming an image excellent in friction resistance in addition to the above-described advantages.

### DESCRIPTION OF EXEMPLARY EMBODIMENTS

The invention has been made in order to solve at least one part of the above-described problems and can be realized as the following aspects or application examples.

### Application Example 1

According to one aspect of a non-aqueous ink jet ink composition according to the invention, C.I. Pigment Orange 43 as a pigment and one or more kinds of compounds represented by the following general formula (1) as a solvent are contained and the content of water contained in the ink composition is 0.1% by mass or more and 2% by mass or less,

R¹O—(R²O)ₘ—R³ (1)

in which, in general formula (1), R¹ and R³ each independently represent hydrogen or an alkyl group in which the number of carbon atoms is 1 or more and 4 or less, at least one of R¹ and R³ is an alkyl group in which the number of carbon atoms is 1 or more and 4 or less, R² represents an alkylene group having 2 or 3 carbon atoms, and m represents an integer of 2 or 3.

According to the non-aqueous ink jet ink composition of Application Example 1, an image excellent in weatherability and printed image quality can be formed and also the generation of foreign substances in ink is suppressed and excellent long-term storage stability is achieved.

### Application Example 2

In the non-aqueous ink jet ink composition of Application Example 1, the content of the pigment contained in the ink composition can be 1% by mass or more and 6% by mass or less.

### Application Example 3

In the non-aqueous ink jet ink composition of Application Example 1 or Application Example 2, the total content of the one or more kinds of the compounds represented by general formula (1) contained in the ink composition can be 10% by mass or more and 90% by mass or less.

### Application Example 4

In the non-aqueous ink jet ink composition of any one of Application Example 1 to Application Example 3, a compound having a flash point of 70° C. or less among the compounds represented by general formula (1) can be contained and the total content of the one or more kinds of the compounds contained in the ink composition can be 50% by mass or more.

### Application Example 5

In the non-aqueous ink jet ink composition of any one of Application Example 1 to Application Example 4, one or more kinds of cyclic esters can be further contained as the solvent and the total content of the one or more kinds of the cyclic esters contained in the ink composition can be 5% by mass or more and 40% by mass or less.

### Application Example 6

In the non-aqueous ink jet ink composition of any one of Application Example 1 to Application Example 5, a vinyl chloride resin can be further contained.

### Application Example 7

In the non-aqueous ink jet ink composition of any one of Application Example 1 to Application Example 6, the content of the water can be 0.1% by mass or more and 1% by mass or less.

Hereinafter, a preferable embodiment of the invention is described. The embodiment described below describes an example of the invention. The invention is not limited to the following embodiment at all and also includes various kinds of modifications carried out in the range where the scope of the invention is not altered. All the configurations described below are not always indispensable configurations of the invention.

### 1. Non-Aqueous Ink Jet Ink Composition

A non-aqueous ink jet ink composition according to the embodiment contains a solvent and a pigment, and the content of water contained in the ink composition is 0.1% by mass or more and 2% by mass or less. The non-aqueous ink jet ink composition according to the embodiment is an ink containing a volatile solvent (mainly organic solvent) as the main component. The ink is made to adhere onto a recording medium, and then the solvent is dried by heating or at normal temperature to fix a solid content for recording. Therefore, the ink is different from a photo-curable ink which is cured by irradiation of radial rays (light).

When the “non-aqueous” ink jet ink composition in the invention means that water is not intentionally added in producing the ink composition and moisture which is inevitably contained during production or storage of the ink composition may be contained.

Hereinafter, each component contained in the non-aqueous ink jet ink composition according to the embodiment is described.

### 1.1. Solvent

The non-aqueous ink jet ink composition according to the embodiment contains one or more kinds of compounds represented by the following general formula (1) as the solvent.

### 1.1.1. Compound Represented by General Formula (1)

R¹O—(R²O)ₘ—R³ (1)

In general formula (1), R¹ and R³ each independently represent hydrogen or an alkyl group in which the number of carbon atoms is 1 or more and 4 or less. At least one of R¹ and R³ is an alkyl group in which the number of carbon atoms is 1 or more and 4 or less. R² represents an alkylene group having 2 or 3 carbon atoms. m represents an integer of 2 or 3.

Herein, the alkyl group in which the number of carbon atoms is 1 or more and 4 or less can be a linear or branched alkyl group, and, specifically, a methyl group, an ethyl group, an n-propyl group, an iso-propyl group, an n-butyl group, a sec-butyl group, and a tert-butyl group are mentioned. As the alkylene group having 2 or 3 carbon atoms, an ethylene group (dimethylene) and a propylene group (trimethylene or methylethylene) are mentioned. One or two or more of the compounds represented by general formula (1) may be contained.

Specific examples of the compounds represented by general formula (1) include diethylene glycol monomethyl ether (105° C.) (sometimes abbreviated as “DEGmME”), triethylene glycol monomethyl ether (139° C.), diethylene glycol monoisopropyl ether (101° C.), diethylene glycol monobutyl ether (120° C.), triethylene glycol monobutyl ether (156° C.), diethylene glycol monoisobutyl ether (112° C.), dipropylene glycol monomethyl ether (76.5° C.), tripropylene glycol monomethyl ether (123° C.), dipropylene glycol monopropyl ether (108° C.), dipropylene glycol monobutyl ether (117° C.), tripropylene glycol monobutyl ether (138° C.), diethylene glycol dimethyl ether (56° C.) (sometimes abbreviated as “DEGdME”), triethylene glycol dimethyl ether (113° C.) (sometimes abbreviated as “TriEGdME”), diethylene glycol methyl ethyl ether (64° C.) (sometimes abbreviated as “DEGMEE”), diethylene glycol diethylether (70.8° C.) (sometimes abbreviated as “DEGDEE”), diethylene glycol dibutyl ether (122° C.) (sometimes abbreviated as “DEGdBE”), diethylene glycol butyl methyl ether (94° C.) (sometimes abbreviated as “DEGBME”), dipropylene glycol dimethyl ether (65° C.), tripropyrene glycol dimethyl ether, and the like. The numerical values in the brackets in the examples mentioned above indicate the flash point.

The “flash point” above refers to the flash point determined by a Cleveland open cup flash point tester in the case where the flash point determined by a tag closed cup flash point tester is more than 80° C. In the case where the flash point determined by a tag closed cup flash point tester is 80° C. or less, the flash point above refers to the flash point determined by a tag closed cup flash point tester when the kinetic viscosity of the solvent at the flash point is less than 10 cSt or refers to the flash point determined by a Seta closed cup flash point tester when the kinetic viscosity of the solvent at the flash point is 10 cSt or more.

Among the compounds, from the viewpoint of achieving both the drying properties and the printed image quality on a recording medium of the non-aqueous ink jet ink composition, a compound having a flash point of 75° C. or less is preferably contained, a compound having a flash point of 70° C. or less is more preferably contained, a compound having a flash point of 50° C. or more and 70° C. or less is more preferably contained, and a compound having a flash point of 55° C. or more and 68° C. or less is particularly preferably contained. The content of the compound (compound having a flash point of 75° C. or less among the compounds represented by general formula (1)) based on the total mass of the non-aqueous ink jet ink composition (the total amount of the compounds when using two or more kinds of the compound) is preferably 50% by mass or more, more preferably 60% by mass or more, and particularly preferably 65% by mass or more. In particular, the content of the compound having a flash point of 70° C. or less among the compounds (the total amount of the compounds when using two or more kinds of the compound) is preferably 50% by mass or more, more preferably 60% by mass or more, and particularly preferably 65% by mass or more. When the content of the compound(s) contained in the ink composition is (are) in the ranges mentioned above, the drying properties of the non-aqueous ink jet ink composition can be improved and wetting and spreading properties and aggregation unevenness (aggregation of the pigment and the like) on an image to be formed can be suppressed and the glossiness can be increased. Moreover, as compared with other solvents, the storage stability of the non-aqueous ink jet ink composition tends to be improved. As a reason therefor, it is assumed that this is because, in the compound having a flash point of 75° C. or less among the compounds represented by general formula (1), an increase in moisture during long-term storage of the ink can be suppressed.

The content of the compound(s) represented by general formula (1)) based on the total mass of the non-aqueous ink jet ink composition (the total amount of the compounds when using two or more kinds of the compound) is preferably 10% by mass or more and 90% by mass or less, more preferably 20% by mass or more and 80% by mass or less, still more preferably 30% by mass or more and 75% by mass or less, and particularly preferably 40% by mass or more and 70% by mass or less.

### 1.1.2. Cyclic Ester

The non-aqueous ink jet ink composition according to the embodiment preferably contains cyclic ester (cyclic lactone). Due to the fact that the cyclic ester is contained, the non-aqueous ink jet ink composition can dissolve a part of a recording surface (for example, a recording surface containing vinyl chloride resin) of the recording medium to cause the non-aqueous ink jet ink composition to permeate into the recording medium. Due to the permeation of the ink into the recording medium as described above, the friction resistance (rubbing fastness) of an image recorded on the recording medium can be increased. In other words, since the cyclic ester has high affinity with the vinyl chloride resin, components of the non-aqueous ink jet ink composition can be easily permeated (easily bitten) into the recording surface. It is considered that, as the result of such action of the cyclic ester, an image excellent in friction resistance can be formed even when the non-aqueous ink jet ink composition containing the cyclic ester is placed under severe conditions, such as an outdoor environment.

The cyclic ester is a compound having a structure in which, in one molecule having a hydroxyl group and a carboxyl group, the hydroxyl group and the carboxyl group are subjected to dehydration condensation in the molecule. The cyclic ester is a compound having a heterocycle containing two or more carbon atoms and one oxygen atom, having a structure in which a carbonyl group is arranged adjacent to the oxygen atom forming the heterocycle, and being generically referred to as lactone.

Among the cyclic esters, β-propiolactone, β-butyrolactone, γ-butyrolactone, γ-valerolactone, γ-caprolactone, σ-valerolactone, ε-caprolactone, and the like can be mentioned as those having a simple structure. The number of ring members of the cyclic esters is not particularly limited and, for example, an arbitrary side chain may be bonded to the ring members of the heterocyclic ring. The cyclic esters may be used alone or as a mixture of two or more kinds thereof.

Among the cyclic esters mentioned above, from the viewpoint of further increasing the friction resistance of an image to be formed with the non-aqueous ink jet ink composition according to the embodiment, cyclic esters having a 3 or more and 7 or less-membered ring are preferable and cyclic esters having a 5 or more and 6 or less-membered ring are more preferable and it is more preferable for the cyclic esters not to have a side chain in any case. Specific examples of such cyclic esters include γ-butyrolactone and σ-valerolactone. Such cyclic esters have high affinity particularly with polyvinyl chloride. Therefore, when caused to adhere to a recording medium containing polyvinyl chloride, an effect of improving friction resistance can be conspicuously obtained.

When the cyclic ester is blended, the content of the cyclic ester based on the total mass of the non-aqueous ink jet ink composition (the total amount of the cyclic esters when using two or more kinds thereof) is preferably 5% by mass or more and 40% by mass or less and more preferably 10% by mass or more and 30% by mass or less.

### 1.1.3. Other Solvents

For the non-aqueous ink jet ink composition according to the embodiment, the following compounds can be used as the solvent besides the compounds represented by general formula (1) and the cyclic esters.

Examples of such solvents include, for example, alcohols (methyl alcohol, ethyl alcohol, propyl alcohol, butyl alcohol, isopropyl alcohol, fluorinated alcohol, and the like), ketones (acetone, methyl ethyl ketone, cyclohexanone, and the like), carboxylate esters (methyl acetate, ethyl acetate, propyl acetate, butyl acetate, methyl propionate, ethyl propionate, and the like), ethers (diethylether, dipropylether, tetrahydrofuran, dioxane, and the like), polyhydric alcohols (ethylene glycol, diethylene glycol, triethylene glycol, polyethylene glycol, polypropylene glycol, propylene glycol, butylene glycol, 1,2,6-hexane triol, thioglycol, hexylene glycol, glycerol, trimethylol ethane, trimethylol propane, and the like), and the like.

As the solvent, (polyhydric) alcohols may be contained. Examples of the (polyhydric) alcohols include glycerol, propylene glycol, dipropylene glycol, 1,2-butanediol, 1,2-pentanediol, 1,2-hexanediol, 1,2-heptanediol, 3-methyl-1,3-butanediol, 2-ethyl-2-methyl-1,3-propanediol, 2-methyl-1,3-propanediol, 2-methyl-2-propyl-1,3-propanediol, 2,2-dimethyl-1,3-propanediol, 2-methyl pentane 2,4-diol, and the like.

The total content when the (polyhydric) alcohols are blended in the non-aqueous ink jet ink composition is preferably 0.05% by mass or more and 30% by mass or less and more preferably 0.1% by mass or more and 30% by mass or less based on the total mass of the non-aqueous ink jet ink composition from the viewpoint of an effect of improving wetting and spreading properties on a recording medium and permeability to reduce density unevenness and securing storage stability and discharge reliability. Due to the fact that the content of the (polyhydric) alcohols is in the ranges mentioned above, the wettability, permeability, and drying properties of ink are improved and an image having good printing density (color development properties) are obtained in some cases. Moreover, due to the fact that the content of the (polyhydric) alcohols is in the ranges mentioned above, the viscosity of ink can be appropriately adjusted, so that the occurrence of clogging of a nozzle and the like can be reduced in some cases.

Moreover, amines may be blended in the non-aqueous ink jet ink composition. For example, hydroxylamines, such as triethanolamine, tripropanolamine, tributanolamine, N,N-dimethyl-2-amino ethanol, and N,N-diethyl-2-amino ethanol, are mentioned, and one kind or two or more kinds thereof can be used. The total content when the amines are blended is preferably 0.05% by mass or more and 5% by mass or less and more preferably 0.1% by mass or more and 3% by mass or less based on the total mass of the non-aqueous ink jet ink composition.

Examples of the solvent include higher fatty acid esters, such as methyl laurate, isopropyl hexadecanoate (isopropyl palmitate), isopropyl myristate, methyl oleate, and ethyl oleate, dibasic acid diesters in which dicarboxylic acids of aliphatic hydrocarbons having 2 to 8 carbon atoms (The number of carbon does not include carbon of a carboxyl group.) are diesterified with alkyl groups having 1 to 5 carbon atoms, and alkyl amides (N,N-dimethyl decane amide and the like) in which monocarboxylic acids of aliphatic hydrocarbons having 6 to 10 carbon atoms (The number of carbon does not include carbon of a carboxyl group.) are amidated (Substituents substituting amide nitrogen atoms each are independently a hydrogen atom and an alkyl group in which the number of carbon atoms is 1 or more and 4 or less).

One or two or more kinds of the other solvents mentioned herein can be added in an appropriate blending amount to the non-aqueous ink jet ink composition.

### 1.2. Pigment

The non-aqueous ink jet ink composition according to the embodiment contains a C.I. Pigment Orange 43 (PO43) as the pigment.

The PO43 is a pigment of CAS registry number 4424-06-0 and has a chemical name of bisbenzoimidazo[2,1-b:2′,1′-i]benzo[lmn][3,8]phenanthroline-8,17-dione or 1,8-(1H-benzimidazole-2,1-diylcarbonyl)-5,4-(1H-benzimidazole-2,1-diylcarbonyl)naphthalene. The PO43 has a perinone structure, and “perinone orange” is given as a common name. The hue of the PO43 is a bright reddish orange. The “C.I.” is the abbreviation for the color index.

For the PO43, commercially-available items can also be used and are available as “Host aperm Orange” and “PV Gast Orange GRL” of Clariant, “Fasogen Super Orange 6200” manufactured by DIC, Inc., and “Lionogen Orange GR-F” manufactured by Toyo Ink, Inc., and the like, for example.

When adding the PO43 to ink, it is desirable to prepare a pigment dispersion, and then add the same to ink. A method for producing the pigment dispersion is not particularly limited and, for example, a method including charging the PO43, a medium, and other arbitrary components, and then dispersing them by a high-speed disperser or the like, and the like are mentioned. Furthermore, the dispersion may be performed by a bead mill, roll mill, or the like as necessary. Then, in order to remove particles having a size equal to or larger than a certain size which may be contained in the finally obtained pigment dispersion, filter filtration and centrifugal separation are performed. When performing the filter filtration, the pore size (size of a mesh) of a filter may be selected as appropriate in such a manner as to adjust the particle diameter of particles contained in the pigment dispersion to a predetermined particle diameter. It is a matter of course that the filter filtration may be performed in the preparation stage of the pigment dispersion, may be performed in the stage of preparing ink, or may be performed in each of the stage of preparing the pigment dispersion and the stage of preparing ink.

The volume average particle diameter of the PO43 contained in the non-aqueous ink jet ink composition according to the embodiment is preferably 100 nm or more and 400 nm or less and more preferably 150 nm or more and 300 nm or less. Herein, the volume average particle diameter of the pigment can be evaluated by a laser diffraction scattering method. Specifically, the volume average particle diameter can be measured by diluting a sample (pigment) formed into ink with DEGdEE (diethylene glycol diethylether) to be 1000 ppm or less, and then reading the value of the median diameter D50 under a 20° C. environment using a laser diffraction scattering measuring device (for example, Microtrac UPA250 (manufactured by Nikkiso Co., Ltd.)). Therefore, even when two or more kinds of PO43 having a different volume average particle diameter are mixed and used, the volume average particle diameter of each PO43 and the volume average particle diameter of a mixture can also be measured.

Also when two or more kinds of PO43 having a different volume average particle diameter are mixed and used, a preferable volume average particle diameter of each PO43 is 100 nm or more and 400 nm or less. The lower limit is more preferably 150 nm or more and the upper limit is more preferably 350 nm or less and still more preferably 300 nm or less.

Due to the fact that the non-aqueous ink jet ink composition according to the embodiment contains the C.I. Pigment Orange 43 (PO43) having a volume average particle diameter of 100 nm or more and 400 nm or less as the pigment, the balance of the comprehensive performance including weatherability, printing stability, and friction resistance can be improved.

With respect to the volume average particle diameter of the PO43, a commercially available item having a volume average particle diameter in the ranges mentioned above can be used as it is but the volume average particle diameter can be adjusted as follows. More specifically, a solvent (part or all) is mixed, and then the mixture (pigment dispersion solvent) is treated as appropriate by a ball mill, a bead mill, ultrasonication and/or a jet mill, or the like, whereby the particle diameter distribution and the volume average particle diameter can be adjusted.

Moreover, as a method for adjusting the volume average particle diameter of the PO43, a method including preparing a pigment having a small primary particle diameter, and then performing dispersion while changing the addition amount of a dispersant (described later) when mixing the same with a solvent (part or all) can be employed. More specifically, when a dispersant is sufficiently added, aggregation of primary particles can be prevented, and thus dispersion at a particle diameter which is not so different from the particle diameter of the primary particles can be performed, so that a volume average particle diameter based on the small primary particle diameter can be achieved. On the contrary, by reducing the addition amount of a dispersant, the primary particles are aggregated, and thus a volume average particle diameter based on the particle diameter of secondary particles can be achieved. In this case, the use of a start pigment having a smaller primary particle diameter is preferable because the degree of freedom of the adjustment of the volume average particle diameter increases. When the degree of freedom of the adjustment of the volume average particle diameter is demanded to further increase, the obtained pigment may be crushed by a ball mill or the like once as described above to further reduce the size, and then the average particle diameter may be adjusted using a dispersant.

The content of the PO43 based on the total mass of the non-aqueous ink jet ink composition according to the embodiment is preferably 1% by mass or more and 10% by mass or less, more preferably 1% by mass or more and 8% by mass or less, still more preferably 1% by mass or more and 6% by mass or less, and particularly preferably 1% by mass or more and 5% by mass or less. Due to the fact that the content of the PO43 is in the ranges mentioned above, an orange ink of a spot color having excellent color development properties can be obtained. In an image formed with the ink, the weatherability is good.

On the other hand, the non-aqueous ink jet ink composition according to the embodiment may further contain a coloring material other than the PO43 described above. Examples of such a coloring material include pigments and dyes having a hue similar to the hue of the PO43, and include pigments given with the color index number of a C.I. Pigment Orange and pigments given with the color index number of a C.I. Pigment Red.

### 1.3. Water

The non-aqueous ink jet ink composition according to the embodiment contains water in a proportion of 0.1% by mass or more and 2% by mass or less. When producing the non-aqueous ink jet ink composition according to the embodiment, about 3% by mass of water is mixed in the non-aqueous ink jet ink composition in many cases because a very small amount of moisture is contained in the solvent or the solvent absorbs moisture in the atmosphere during the production. Therefore, in order to adjust the content of water in the non-aqueous ink jet ink composition according to the embodiment to 0.1% by mass or more and 2% by mass or less, it is necessary to adjust the moisture amount by using one passing through a process of performing dehydration with a dehydrating agent as each solvent to be used or adding a collectable dehydrating agent to the obtained non-aqueous ink jet ink composition.

The chemical name of the PO43 is bisbenzoimidazo[2,1-b:2′,1′-i]benzo[lmn][3,8]phenanthroline-8,17-dione or 1,8-(1H-benzimidazole-2,1-diylcarbonyl)-5,4-(1H-benzimidazole-2,1-diylcarbonyl)naphthalene. The chemical structural formula of the PO43 is as shown in the following formula (2). As shown in the following formula (2), since the PO43 has a chemical structure not having a hydrophilic group, the PO43 is likely to be influenced by water. Therefore, when water is contained in a proportion exceeding 2% by mass in the non-aqueous ink jet ink composition, the dispersion system of the PO43 is destroyed, and thus each PO43 is aggregated, so that it is assumed that an increase in particle diameter and an increase in viscosity are likely to occur. As a result, a nozzle of discharging ink of an ink jet printer is clogged, so that a problem such as occurrence of missing dots may occur. On the other hand, in order to adjust the content of water in the non-aqueous ink jet ink composition to be less than 0.1% by mass, a dehydrating process takes a considerable time, and further it is difficult to actually produce the same due to the influence of moisture in the atmosphere.

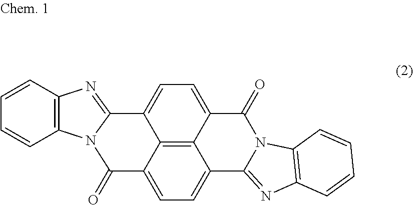 [SMILES: O=c1c2ccc3c4c(ccc(c24)c2nc4ccccc4n12)c(=O)n1c2ccccc2nc31]

The content of water in the non-aqueous ink jet ink composition according to the embodiment is preferably 0.1% by mass or more and 1% by mass or less and more preferably 0.1% by mass or more and 0.7% by mass or less from the viewpoint of effectively suppressing the aggregation of each PO43.

The content of water in the non-aqueous ink jet ink composition according to the embodiment can be measured by quantifying the produced non-aqueous ink jet ink composition with a Karl Fischer moisture meter. As such a device, a trace level water content determination device “AQ-2200” manufactured by Hiranuma Sangyo Corporation, a Karl Fischer moisture meter “MKV-710S” manufactured by Kyoto Electronics Manufacturing Co., Ltd., and the like can be used, for example.

### 1.4. Other Components

The non-aqueous ink jet ink composition according to the embodiment may further contain components described below, such as a vinyl chloride resin, an acrylic resin, a surfactant, and a dispersant.

### 1.4.1. Vinyl Chloride Resin

Examples of the vinyl chloride resin which can be used for the non-aqueous ink jet ink composition according to the embodiment include copolymers (hereinafter also referred to as a “vinyl chloride acetate copolymer”) containing constituent units derived from vinyl chloride and vinyl acetate. The vinyl chloride acetate copolymer can be dissolved in the compounds represented by general formula (1) shown above. As a result, ink can be firmly fixed to the surface of a recording medium containing the vinyl chloride resin due to the vinyl chloride acetate copolymer dissolved in the compounds represented by general formula (1).

The vinyl chloride acetate copolymer can be obtained by a usual method and can be obtained by suspension polymerization, for example. Specifically, the suspension polymerization can be performed by charging water, a dispersant, and a polymerization initiator into a polymerizer, performing dehydration, and then pressing vinyl chloride and vinyl acetate thereinto or the suspension polymerization can be performed by pressing a part of vinyl chloride and vinyl acetate into a polymerizer to start a reaction, and then pressing the remaining vinyl chloride into the polymerizer during the reaction.

The vinyl chloride acetate copolymer preferably contains 70 to 90% by mass of the vinyl chloride unit as the configuration. When the content is in the range mentioned above, the vinyl chloride acetate copolymer is stably dissolved in the ink jet ink composition, and therefore the long-term storage stability is excellent. Furthermore, the discharge stability is excellent and excellent fixability to a recording medium can be achieved.

Moreover, the vinyl chloride acetate copolymer may have other constituent units as necessary together with the vinyl chloride unit and the vinyl acetate unit and, for example, a carboxylic acid unit, a vinyl alcohol unit, and a hydroxyalkyl acrylate unit are mentioned, and the vinyl alcohol unit is particularly preferably mentioned. The constituent units can be obtained by using a monomer corresponding to each unit mentioned above. Specific examples of monomers giving the carboxylic acid unit include maleic acid, itaconic acid, maleic acid anhydride, itaconic acid anhydride, acrylic acid, and methacrylic acid, for example. Specific examples of monomers giving the hydroxyalkyl acrylate unit include hydroxyethyl (meth)acrylate, hydroxyethyl vinyl ether, and the like, for example. The content of these monomers is not limited insofar as the effects of the invention are not impaired and, for example, copolymerization can be performed in the range of 15% by mass or less of the total amount of the monomers.

As the vinyl chloride acetate copolymer, commercially available items may be use and, for example, SOLBIN CN, SOLBIN CNL, SOLBIN CSR, SOLBIN TA5R, SOLBIN CL (all manufactured by Nisshin Chemical Co., Ltd.), and the like are mentioned.

The average polymerization degree of the vinyl chloride resin is not particularly limited and is preferably 150 to 1100 and more preferably 200 to 750. When the average polymerization degree of the vinyl chloride resin is in the ranges mentioned above, the vinyl chloride resin is stably dissolved into the non-aqueous ink jet ink composition according to the embodiment, and therefore the long-term storage stability is excellent. Furthermore, the discharge stability is excellent and excellent fixability to a recording medium can be achieved. The average polymerization degree of the vinyl chloride resin is calculated from a measured specific viscosity and can be determined according to a method for calculating the average polymerization degree described in “JIS K6720-2”.

The number average molecular weight of the vinyl chloride resin is not particularly limited and is preferably 10000 to 50000 and more preferably 12000 to 42000. The number average molecular weight can be measured by GPC and can be determined as a relative value in terms of polystyrene.

The content of the vinyl chloride resin in the non-aqueous ink jet ink composition according to the embodiment can be set to, for example, 0.05% by mass or more and 6% by mass or less and preferably 0.5% by mass or more and 4% by mass or less. When the content of the vinyl chloride resin is in the ranges mentioned above, excellent fixability to a vinyl chloride-based recording medium is achieved due to the vinyl chloride resin dissolved in the compound represented by general formula (1). As the vinyl chloride resin, any resin can be used besides the vinyl chloride acetate copolymer described above insofar as at least a constituent unit derived from vinyl chloride is contained.

In the non-aqueous ink jet ink composition according to the embodiment, the vinyl chloride resin and the compound represented by general formula (1) are preferably contained at an amount ratio based on mass of 1:5 to 1:40. When the amount ratio is in the ranges mentioned above, the vinyl chloride resin can be easily dissolved into the compound represented by general formula (1). Therefore, the ink fixability to the surface of a recording medium containing the vinyl chloride resin can be improved and clogging of a nozzle becomes difficult to occur.

### 1.4.2. Acrylic Resin

To the non-aqueous ink jet ink composition according to the embodiment, acrylic resin may be added besides the vinyl chloride resin from the viewpoint of increasing the adhesiveness of an ink coating film of an image.

Examples of the acrylic resin include, for example, poly(meth)acrylic acid, poly(meth)methyl acrylate, poly(meth)ethyl acrylate, (meth)acrylic acid-(meth)acrylic acid ester copolymer resin, styrene-(meth)acryl copolymer resin, ethylene-(meth)acrylate copolymer resin, ethylene alkyl(meth)acrylate resin, ethylene-(meth)acrylic acid ester copolymer resin, and the like.

As the acrylic resin mentioned above, commercially-available items may be used and, for example, ACRYPET MF (Trade name, manufactured by Mitsubishi Rayon Co., Ltd., acrylic resin), SUMIPEX LG (Trade name, manufactured by Sumitomo Chemical Co., Ltd., acrylic resin), PARALOID B series (Trade name, manufactured by Rohm and Haas Co., acrylic resin), PARAPET G-1000P (Trade name, manufactured by Kuraray Co., Ltd., acrylic resin), and the like are mentioned. In the invention, the (meth)acrylic acid refers to both acrylic acid and methacrylic acid and the (meth)acrylate refers to both acrylate and methacrylate.

The content of the acrylic resin in the non-aqueous ink jet ink composition according to the embodiment can be set to, for example, 0.5% by mass or more and 10% by mass or less and preferably 0.5% by mass or more and 6% by mass or less. When the content of the acrylic resin is in the ranges mentioned above, excellent fixability to the vinyl chloride-based recording medium is achieved.

### 1.4.3. Surfactant

To the non-aqueous ink jet ink composition according to the embodiment, a silicon-based surfactant, a fluorine-based surfactant, or a polyoxy ethylene derivative which is a nonionic surfactant may be added besides the organic solvent described above from the viewpoint of reducing the surface tension and increasing the wettability with a recording medium.

As the silicon-based surfactant, it is preferable to use polyester-modified silicon and polyether-modified silicon. As specific examples, BYK-347 and 348, BYK-UV3500, 3510, 3530, and 3570 (all manufactured by BYK Chemie, Japan) are mentioned.

As the fluorine-based surfactant, it is preferable to use a fluorine-modified polymer, and BYK-340 (manufactured by BYK Chemie, Japan) is mentioned as a specific example.

As the polyoxy ethylene derivative, it is preferable to use an acetylene glycol-based surfactant. As specific examples, Surfynol 82, 104, 465, and 485, and TG (all manufactured by Air Products, Japan, Inc.), Olefin STG and E1010 (all manufactured by Nisshin Chemical Co., Ltd.), Nissan Nonion A-10R and A-13R (all manufactured by NOF CORPORATION), FLOWLEN TG-740W and D-90 (manufactured by Kyoeisha Chemical Co., Ltd.), NOIGEN CX-100 (manufactured by Daiichi Kogyo Seiyaku Co., Ltd.), and the like are mentioned.

The content of the surfactant in the non-aqueous ink jet ink composition according to the embodiment is preferably 0.05% by mass or more and 3% by mass or less and more preferably 0.5% by mass or more and 2% by mass or less.

### 1.4.4. Dispersant

For the non-aqueous ink jet ink composition according to the embodiment, arbitrary dispersants for use in usual ink compositions can be used from the viewpoint of increasing the dispersion stability of the pigment. Specific examples of such dispersants include polyester-based polymer compounds, such as Hinoacto KF1-M, T-6000, T-7000, T-8000, T-8350P, and T-8000E (all manufactured by Takefu Fine Chemicals Co., Ltd.), Solsperse 20000, 24000, 32000, 32500, 33500, 34000, 35200, and 37500 (all “Solsperse” manufactured by LUBRIZOL), Disperbyk-161, 162, 163, 164, 166, 180, 190, 191, and 192 (all manufactured by BYK Chemie, Japan), FLOWLEN DOPA-17, 22, 33, and G-700 (all manufactured by Kyoeisha Chemical Co., Ltd.), AJISPER PB821 and PB711 (all manufactured by Ajinomoto Co., Inc.), LP4010, LP 4050, and LP 4055, POLYMER 400, 401, 402, 403, 450, 451, and 453 (all manufactured by EFKA Chemicals), and the like.

As the dispersants, metallic soap, a polymer dispersant having a basic group, and the like can also be used and the polymer dispersant having a basic group is preferable. One having an amino group, an imino group, or a pyrrolidone group as the basic group is particularly preferable. As the polymer dispersants having the basic groups, polyalkylene polyamine, a salt of a long chain polyaminoamide and a high molecular weight acid ester, a salt of polyaminoamide and polar acid ester, modified polyurethane, polyester polyamine, and the like can be used.

As specific example of the polymer dispersants having the basic groups, “Anti-Terra-U (polyaminoamide phosphate)” manufactured by BYK Chemie, “Anti-Terra-204 (high molecular weight polycarboxylic acid salt)”, and “Disperbyk-101 (polyaminoamide phosphate and acid ester) 130 (polyamide) can be mentioned. Moreover, Solsperse 5000 (phthalocyanine ammonium salt system), 13940 (polyester polyimine), 17000, 18000, 19000 (polyester polyamine), and 11200 (polyester polyimine) manufactured by Avecia Inc., can be mentioned. Moreover, V-216 and V-220 (polyvinyl pyrrolidone with a long chain alkyl group) manufactured by ISP can be mentioned.

The content when the dispersant is used in the ink composition according to the embodiment can be selected as appropriate according to the pigment to be contained and is preferably 5 parts by mass or more and 200 parts by mass or less and more preferably 30 parts by mass or more and 120 parts by mass or less based on 100 parts by mass as the content of the pigment in the ink composition.

### 1.4.5. Others

The non-aqueous ink jet ink composition according to the embodiment can contain substances for giving predetermined performance, such as resin other than the vinyl chloride resin and the acrylic resin, a chelating agent, such as ethylenediaminetetraacetic acid salt (EDTA), an antiseptic/antifungal agent, and an antirust, besides the components described above.

As the resin other than the vinyl chloride resin and the acrylic resin, aliphatic polyester, aromatic polyester, polyurethane, epoxy resin, polyvinyl acetate, ethylene-vinyl acetate copolymer resin, polycarbonate, polyvinyl butyral, polyvinyl alcohol, phenoxy resin, ethyl cellulose resin, cellulose acetate propionate resin, cellulose acetate butyrate, nitrocellulose resin, polystyrene, vinyltoluene-α-methylstyrene copolymer resin, polyamide, polyimide, polysulfone resin, petroleum resin, chlorinated polypropylene, polyolefin, terpene-based resin, rosin-modified phenol resin, various kinds of synthetic rubber, such as NBR, SBR, and MBR, modified substances thereof, and the like may be used, for example. The resin mentioned above may be used alone or as a mixture of two or more kinds thereof.

### 1.5. Applications and Effects

Since the non-aqueous ink jet ink composition according to the embodiment is a non-aqueous ink composition containing the compound represented by general formula (1) shown above, the image quality when recorded on film media, such as a vinyl chloride-based recording medium, is excellent. Therefore, the non-aqueous ink jet ink composition according to the embodiment is particularly suitable for use in signage applications and the like which are exhibited outdoors. The vinyl chloride-based recording medium is not particularly limited insofar as a vinyl chloride resin is contained. Examples of the recording medium containing the vinyl chloride resin include a hard or elastic vinyl chloride-based film or sheet and the like. The non-aqueous ink jet ink composition according to the embodiment enables recording of an image on a non-treated surface in a vinyl chloride resin-based material and has an outstanding effect of eliminating the necessity of the use of an expensive recording medium, such as a former recording medium having a receiving layer, but it is a matter of course that the non-aqueous ink jet ink composition according to the embodiment can be applied even in the case of a base material whose surface is treated with an ink receiving layer.

By setting the content of water to 0.1% by mass or more and 2% by mass or less, the non-aqueous ink jet ink composition according to the embodiment suppresses the occurrence of aggregation (foreign substance) of the PO43 due to long-term storage, and thus the storage stability is improved. Thus, clogging of a nozzle of an ink jet printer can be prevented, so that the discharge reliability can be improved.

Moreover, when the non-aqueous ink jet ink composition according to the embodiment is applied to the use of signage applications and the like which are exhibited outdoors, the weatherability of an image becomes particularly good because the non-aqueous ink jet ink composition according to the embodiment contains the PO-43. Although the friction resistance can be improved by adding the cyclic ester, the cyclic ester tends to have high hygroscopicity, and thus the dispersion stability of the PO43 is likely to be impaired. However, the use of a compound having a flash point of 75° C. or less among the compounds represented by general formula (1) and cyclic ester in combination can achieve both securing of the friction resistance of an image and a further improvement of storage stability, and thus a particularly preferable aspect is achieved.

Moreover, by preparing an ink set containing color ink, such as a cyan ink, a magenta ink, a yellow ink, and a black ink, and the orange ink (ink composition according to the embodiment) of a spot color in combination, color reproduction with a wide gamut can be achieved and the color reproduction is held over a long period of time.

### 2. Examples and Comparative Examples

The invention is further described with reference to Examples and Comparative Examples described below but the invention is not particularly limited at all by the following examples. In Examples and Comparative Examples, “part(s)” and “%” are based on mass unless otherwise particularly specified.

### 2.1. Preparation of Ink Composition

### 2.1.1. Production of Pigment

Into a 500 mL container, 120 mL of ion exchange water, 18 g of hydrochloric acid, 6.8 g of acetic acid, and g of polyoxyalkylene alkyl amine were charged, and then mixed and stirred. Next, 16 g of 2.5-dichloro aniline was charged, ice was added to adjust the liquid temperature to about 5° C., and then 6 g of sodium nitrite was charged and stirred for 30 minutes while holding the liquid temperature in the container at 10° C. or less to obtain a diazotized liquid.

Separately, 200 mL of ion exchange water and 23.5 g of 2-acetoacetylamino-6-ethoxy benzothiazole were charged into a 300 mL container, and then stirred for 30 minutes. Then, 5.2 g of potassium hydroxide was added, and then stirred for 30 minutes to obtain a reaction liquid.

The diazotized liquid obtained above was filtered through a filter paper (No. 5C), and then a filtrate was charged into a 2 L container. Into the filtrate, 1 g of sulfamic acid and 15 g of sodium acetate were charged, and then the liquid temperature was adjusted to 25° C. and the pH was adjusted to 2.0 to 3.0. The reaction liquid was charged, and then stirred for 60 minutes while holding the liquid temperature at 25° C. Next, the liquid temperature was increased to 90° C., and then the mixture was stirred for 30 minutes. Then, an aqueous 30% sodium hydroxide solution was charged to set the pH to 8.5. The finally obtained reaction liquid was filtered, a residue was washed with ion exchange water, and then the residue was dried at 80° C. The dried residue was pulverized by a sample mill to obtain a powdered pigment (coarse raw material).

The coarse raw material thus obtained was dried by heating at 105° C. Into 450 mL of N-methyl-2-pyrrolidone (NMP), 50 g of the coarse raw material was charged, the temperature was increased to 80° C. under stirring (temperature increase time was about 1 hour), and then the mixture was stirred at 80° C. for 2 hours. Then, the mixture was cooled until the temperature reached 30° C. or less, and then filtered through Nutsche. The residue which was separated by filtration was washed with 2 L of ion exchange water, and then the residue which was separated by filtration was obtained as a paste-like pigment dispersion containing a pigment and ion exchange water. Then, the resultant substance was dried by heating at 105° C., and then pulverized by a sample mill to obtain a powdered PO43.

### 2.1.2. Preparation of Pigment Dispersion Liquid

A dispersion liquid was prepared using the pigment obtained above and Solsperse 37500 (manufactured by Lubrizol Corporation) as a dispersant while changing the addition amount of the dispersant in the range of 100 to 400 parts by mass based on 100 parts by mass of the pigment. As a dispersion medium, a solvent having the largest content as a solvent in each ink composition example was used as a dispersion medium, and a pigment dispersion liquid was prepared.

### 2.1.3. Preparation of Ink Composition

Ink compositions different in a pigment type and a solvent type were prepared with the material compositions shown in Tables 1 and 2 using the pigment dispersion liquid prepared above. Each ink composition was prepared by placing components shown in the tables in a container, mixing and stirring the components by a magnetic stirrer for 2 hours, and then filtering the resultant substance through a membrane filter with a pore size of 5 μm to remove impurities, such as wastes and coarse particles. The numerical values of the composition column in Tables 1 and 2 indicated “% by mass”.

For the ink compositions having a water content of 2% by mass or less among the ink compositions of Examples and Comparative Examples, solvents passing through a process of being dehydrated with a dehydrating agent were used as solvents to be used. For the ink compositions containing 3% or more of water as in Comparative Example 5 and Comparative Example 6, commercially available solvents were used as it were without performing the dehydration process, and ion exchange water was added to adjust the content of water. For the ink composition containing 0.1% by mass of water of Example 8, a solvent dehydrated with a dehydrating agent was used as a solvent to be used but the dehydration took a considerable time.

Each ink composition thus obtained immediately after the preparation was measured for the moisture amount using a Karl Fischer moisture meter (Hiranuma Sangyo Corporation, Model “AQ-2200”). The results are collectively shown in Tables 1 and 2.

### 2.2. Evaluation Tests

### 2.2.1. Evaluation of Weatherability

Solid printing was performed at a recording resolution of 720×720 dpi on a vinyl chloride banner sheet (manufactured by 3M, Model No. IJ51 (polyvinyl chloride)) with the ink compositions of Examples and Comparative Examples using an ink jet printer (manufactured by Seiko Epson Corp., Model “SC-570650”) to obtain recorded matter. The obtained recorded matter was charged into a chamber of a xenon weather meter (manufactured by Suga Test Instruments Co., Ltd.), and then subjected to a cycle test of “Light irradiation for 40 minutes”→“Light irradiation+Water dripping for 20 minutes”→“Light irradiation for 60 minutes”→“Water dripping for 60 minutes”. The execution conditions of the xenon weather meter are as follows. This cycle test was continuously performed for 4 weeks, and, after 4 weeks, the recorded matter was taken out. The taken-out recorded matter was measured for the OD value using a Gretag densitometer (manufactured by Gretag-Macbeth AG). Then, the OD value residual ratio (%) was determined, and then judged based on the following criteria.

### Judgment Criteria

◯: The OD value residual ratio is 90% or more.
Δ: The OD value residual ratio is 81% or more and less than 90%.
x: The OD value residual ratio is less than 81%.
Execution conditions of xenon weather meter
Temperature and humidity: 40° C./50% RH
Irradiation intensity: 300 to 400 nm, 60 W/m²

### 2.2.2. Evaluation of Printed Image Quality

### (1) Evaluation of Aggregation Unevenness

Solid printing with a recording resolution of 720×720 dpi was performed at a 100% density on a vinyl chloride banner sheet (manufactured by 3M, Model No. IJ51 (polyvinyl chloride)) with the ink compositions of Examples and Comparative Examples using an ink jet printer (manufactured by Seiko Epson Corp., Model “SC-570650”), and then drying was performed for 60 minutes under a 25° C./65% RH (relative humidity) environment. Then, the temperatures of samples for evaluation were returned to room temperature (25° C.), and then the aggregation unevenness of the pigment on the recording surface of the samples for evaluation was visually observed to evaluate the aggregation unevenness. The judgment criteria are as follows.

### Judgment Criteria

◯: Aggregation unevenness is not observed.
Δ: Slight aggregation unevenness is observed.
X: Aggregation unevenness is noticeable.

### (2) Evaluation of Glossiness

Samples for evaluation obtained in <Evaluation of aggregation unevenness> above were measured for the glossiness at 20° reflection of the recording surface using a photometer MULTI Gloss 268 (manufactured by Konica Minolta Co., Ltd.). The judgment criteria are as follows.

### Judgment Criteria

◯: 50 or more
Δ: 30 or more and less than 50
x: Less than 30

### (3) Evaluation of Printed Image Quality

The printed image quality was evaluated by comprehensive judgment based on the evaluation of the aggregation unevenness and the glossiness. The judgment criteria are as follows.

### Judgment Criteria

◯: Both the evaluation of aggregation unevenness and the evaluation of glossiness are judged as ◯.
Δ: The evaluation of aggregation unevenness and the evaluation of glossiness are not judged as X and either one is judged as Δ.
x: Either the evaluation of aggregation unevenness or the evaluation of glossiness is judged as X.

### 2.2.3. Evaluation of Friction Resistance

Solid printing with a recording resolution of 720×720 dpi was performed at a 100% density on a vinyl chloride banner sheet (manufactured by 3M, Model No. IJ51 (polyvinyl chloride)) with the ink compositions of Examples and Comparative Examples using an ink jet printer (manufactured by Seiko Epson Corp., Model “SC-570650”), and then drying was performed for 60 minutes under a 25° C./65% RH (relative humidity) environment. Then, the temperatures of samples for evaluation were returned to room temperature (25° C.), and then the samples for evaluation were evaluated for friction resistance according to JIS K5701 (ISO 11628) using a Gakushin-type rubbing fastness tester (manufactured by TESTER SANGYO CO., LTD., Product name “AB-301”). Specifically, a cotton cloth was placed on the recording surface of the samples for evaluation, and then rubbed by moving the cotton cloth to the front and the rear by 20 times under a 500 g load. Then, the peeling state of the recording surface of the samples for evaluation after rubbing was visually observed. The judgment criteria are as follows.

### Judgment Criteria

◯: The cotton cloth has no stain. The recording surface is not damaged.
Δ: The recorded matter adheres to the cotton cloth. The recording surface is hardly damaged.
x: The recorded matter adheres to the cotton cloth. The recording surface is damaged.

### 2.2.4. Evaluation of Storage Stability

Into an ink pack configured from a polypropylene film (100 μm in thickness), 700 mL of each ink composition of Example and Comparative Examples was charged, and then the ink pack was sealed. Then, the fluctuation range of the ink physical properties (viscosity and volume average particle diameter) after allowed to stand at 70° C. for 1 week were measured. Even when sealed with the polypropylene film, moisture passed through the film to slightly increase the moisture amount in the ink composition in some cases.

The volume average particle diameter was measured by diluting a sample formed into ink with diethylene glycol diethylether to 1000 ppm, and then reading the value of the volume average particle diameter (Median diameter D50) under a 20° C. environment using a laser diffraction scattering meter (manufactured by Nikkiso Co., Ltd., Device name “Microtrac UPA250”).

With respect to the measurement of the viscosity, the viscosity of the ink at 20° C. and at a share rate of 200/s was measured with a viscometer (manufactured by Anton Paar Japan K.K., Device name “MCR300”).

The judgment criteria of storage stability are as follows.

### Judgment Criteria

⊙: The fluctuation range of viscosity or volume average particle diameter having a larger fluctuation range is less than 2%.
◯: The fluctuation range of viscosity or volume average particle diameter having a larger fluctuation range is 2% or more and less than 6%.
Δ: The fluctuation range of viscosity or volume average particle diameter having a larger fluctuation range is 6% or more and less than 11%.
x: The fluctuation range of viscosity or volume average particle diameter having a larger fluctuation range is 11% or more.

### 2.3. Evaluation Results

The ink compositions and the evaluation results of Example and Comparative Examples are shown in Tables 1 and 2.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| Pigment type | PO43 | 4 | 4 | 4 | 4 | 4 | 4 | 4 | 4 | 1 | 4 |
| | PO64 | — | — | — | — | — | — | — | — | — | — |
| Cyclic ester | γ-butyrolactone | 20 | — | 20 | 20 | 20 | 20 | — | 20 | 20 | 20 |
| | σ-valerolactone | — | 20 | — | — | — | — | — | — | — | — |
| Solvent | DEGMEE | 68 | 68 | — | — | — | 67 | — | — | — | — |
| | DEGdME | — | — | 68 | — | — | — | — | — | — | — |
| | DEGDEE | — | — | — | 68 | — | — | 88 | 68.9 | 71 | 68.3 |
| | DEGBME | — | — | — | — | 68 | — | — | — | — | — |
| | TetraEGdME | — | — | — | — | — | — | — | — | — | — |
| | TetraEGmBE | — | — | — | — | — | — | — | — | — | — |
| | EQUAMIDE M100 | — | — | — | — | — | — | — | — | — | — |
| Dispersant | Solsperse37500 | 4 | 4 | 4 | 4 | 4 | 4 | 4 | 4 | 4 | 4 |
| Surfactant | BYK340 | 1.5 | 1.5 | 1.5 | 1.5 | 1.5 | 1.5 | 1.5 | 1.5 | 1.5 | 1.5 |
| Fixing resin | SOLBIN CL | 1.5 | 1.5 | 1.5 | 1.5 | 1.5 | 1.5 | 1.5 | 1.5 | 1.5 | 1.5 |

| Water | | 1.0 | 1.0 | 1.0 | 1.0 | 1.0 | 2.0 | 1.0 | 0.1 | 1.0 | 0.7 |
|---|---|---|---|---|---|---|---|---|---|---|---|
| Total | | 100.0 | 100.0 | 100.0 | 100.0 | 100.0 | 100.0 | 100.0 | 100.0 | 100.0 | 100.0 |
| Evaluation | Weatherability | ◯ | ◯ | ◯ | ◯ | ◯ | ◯ | ◯ | ◯ | ◯ | ◯ |
| results | Storage stability | ⊙ | ⊙ | ⊙ | ◯ | ◯ | ◯ | ⊙ | ⊙ | ⊙ | ⊙ |
| | Printed image quality | ◯ | ◯ | ◯ | ◯ | ◯ | ◯ | ◯ | ◯ | ◯ | ◯ |
| | Friction resistance | ◯ | ◯ | ◯ | ◯ | ◯ | ◯ | X | ◯ | ◯ | ◯ |

TABLE 2

| | | Comp. | Comp. | Comp. | Comp. | Comp. | Comp. |
|---|---|---|---|---|---|---|---|
| | | Ex. 1 | Ex. 2 | Ex 3 | Ex. 4 | Ex. 5 | Ex. 6 |
| Pigment type | PO43 | — | 4 | 4 | 4 | 4 | 4 |
| | PO64 | 4 | — | — | — | — | — |
| Cyclic ester | γ-butyrolactone | 20 | 20 | 20 | 20 | 20 | 20 |
| | σ-valerolactone | — | — | — | — | — | — |
| Solvent | DEGMEE | 68 | — | — | — | 66 | 65 |
| | DEGdME | — | — | — | — | — | — |
| | DEGDEE | — | — | — | — | — | — |
| | DEGBME | — | — | — | — | — | — |
| | TetraEGdME | — | 68 | — | — | — | — |
| | TetraEGmBE | — | — | 68 | — | — | — |
| | EQUAMIDE M100 | — | — | — | 68 | — | — |
| Dispersant | Solsperse37500 | 4 | 4 | 4 | 4 | 4 | 4 |
| Surfactant | BYK340 | 1.5 | 1.5 | 1.5 | 1.5 | 1.5 | 1.5 |
| Fixing resin | SOLBIN CL | 1.5 | 1.5 | 1.5 | 1.5 | 1.5 | 1.5 |

| Water | | 1.0 | 1.0 | 1.0 | 1.0 | 3.0 | 4.0 |
|---|---|---|---|---|---|---|---|
| Total | | 100.0 | 100.0 | 100.0 | 100.0 | 100.0 | 100.0 |
| Evaluation | Weatherability | X | ◯ | ◯ | ◯ | ◯ | X |
| results | Storage stability | ◯ | Δ | Δ | X | X | ◯ |
| | Printed image quality | ◯ | X | X | X | ◯ | ◯ |
| | Friction resistance | ◯ | ◯ | ◯ | ◯ | ◯ | ◯ |

The abbreviated names or Trade names shown in Tables 1 and 2 are as follows.

### Pigment

### PO43: C.I. Pigment Orange 43

### PO64: C.I. Pigment Orange 64

### Cyclic Ester

γ-butyrolactone: Trade name, manufactured by Kanto Kagaku, Inc.
σ-valerolactone: Trade name, manufactured by Kishida Chemical Co., Ltd.

### Solvent

DEGMEE: Diethylene glycol methyl ethyl ether, Trade name “Hysorb EDM”, manufactured by Toho Chemical Industry Co., Ltd., Flash point of 64° C.
DEGdME: Diethylene glycol dimethyl ether, Trade name “diethylene glycol dimethyl ether”,
manufactured by Tokyo Kasei Kogyo Co., Ltd., Flash point of 56° C.
DEGDEE: Diethylene glycol diethylether, Trade name “diethylene-glycol diethylether”, manufactured by Tokyo Kasei Kogyo Co., Ltd., Flash point of 71° C.
DEGBME: Diethylene glycol butyl methyl ether, Trade name “Hysorb BDM”, manufactured by Toho Chemical Industry Co., Ltd., Flash point of 94° C.
TetraEGdME: Tetraethylene glycol dimethyl ether, Trade name “tetraethylene glycol dimethyl ether”, manufactured by Tokyo Kasei Kogyo Co., Ltd., Flash point of 141° C.
TetraEGmBE: Tetraethylene glycol monobutyl ether, Trade-name “Butycenol 40” manufactured by KH Neochem Co., Ltd., Flash point 177° C.
EQUAMIDE M100: Trade name, manufactured by Idemitsu Kosan, Inc., Amide-based solvent

### Dispersant

Solsperse 37500: Trade name, manufactured by Lubrizol Corporation., Polyester polyamide resin

### Surfactant

BYK340: Trade name, manufactured by BYK Chemie Japan, Inc., Silicon-based surfactant

### Fixing Resin

SOLBIN CL: Trade name, manufactured by Nisshin Chemical Co., Ltd., Vinyl chloride vinyl acetate copolymer

Examples 1 to 10 have showed that images excellent in weatherability and printed image quality can be formed by the use of the non-aqueous ink jet ink composition of the invention. Moreover, it has also been shown that the non-aqueous ink jet ink composition of the invention has an effect of suppressing the occurrence of aggregation of PO43 and also has excellent storage stability.

In Examples 1 to 3, it was found that the storage stability was very excellent due to the fact that glycol ether having a low flash point was contained in a proportion of 50% by mass or more. On the other hand, in Examples 4 to 6, it was found that the storage stability slightly decreased as compared with that of Examples 1 to 3 due to the fact that glycol ether having a slightly high flash point was contained or the moisture amount increased. In Example 7, the cyclic ester which is likely to absorb moisture was not contained, the storage stability was very excellent but the adhering effect to the vinyl chloride base material due to the cyclic ester was not obtained, and thus the friction resistance of the image was not excellent. In Example 8, since the moisture amount in the ink was very small, the storage stability was very excellent but the dehydrating process of the solvent took a considerable time, so that the productivity became poor. In Example 9, since the PO43 content was low, the aggregation of the PO43 hardly occurred, so that the storage stability was very excellent. In Example 10, since the moisture amount in the ink is small, the storage stability was very excellent, and, in the case of such a moisture amount, the dehydrating process of the solvent did not take so much time, so that the productivity was good.

In Comparative Examples 1 and 6, since the PO64 was used, the weatherability of the image became poor. In Comparative Examples 2 to 4, since specific glycol ether was not contained, both the storage stability and the printed image quality became poor. In Comparative Example 5, since the PO43 was contained and 3% by mass of moisture was contained, the aggregation of PO43 occurred and the storage stability deteriorated. In Comparative Example 6, the storage stability was good although 4% by mass of moisture was contained, and therefore it was found that the problem of the storage stability depending on the moisture amount was a problem peculiar to the PO43.

The invention is not limited to the above-described embodiment, and can be modified in various manners. For example, the invention includes the substantially same structure (e.g., structure with same function(s), method(s), and result(s) or structure with the same object(s) and effect(s)) as the structures described with the embodiment. The invention also includes a structure in which non-essential portions of the structures described in the embodiments are replaced. The invention also includes a structure that can demonstrate the same effects or a structure that can achieve the same objects as those in the structures described with the embodiment. The invention also includes a structure in which known techniques are added to the structures described in the embodiment.

The entire disclosure of Japanese Patent Application No. 2015-019142, filed Feb. 3, 2015 is expressly incorporated by reference herein.

What is claimed is:

1. A non-aqueous ink jet ink composition comprising:
C.I. Pigment Orange 43 as a pigment; and
one or more kinds of compounds represented by general formula (1) shown below as a solvent, wherein
a content of water contained in the ink composition is 0.1% by mass or more and 2% by mass or less,
R¹O—(R²O)ₘ—R³ (1)
wherein, in general formula (1), R¹ and R³ each independently represent hydrogen or an alkyl group in which a number of carbon atoms is 1 or more and 4 or less, at least one of R¹ and R³ is an alkyl group in which a number of carbon atoms is 1 or more and 4 or less, R² represents an alkylene group having 2 or 3 carbon atoms, and m represents an integer of 2 or 3.

2. The non-aqueous ink jet ink composition according to claim 1, wherein a content of the pigment contained in the ink composition is 1% by mass or more and 6% by mass or less.

3. The non-aqueous ink jet ink composition according to claim 1, wherein a total content of the one or more kinds of the compounds represented by general formula (1) contained in the ink composition is 10% by mass or more and 90% by mass or less.

4. The non-aqueous ink jet ink composition according to claim 1, wherein a compound having a flash point of 70° C. or less among the compounds represented by general formula (1) is contained and a total content of the one or more kinds of the compounds contained in the ink composition is 50% by mass or more.

5. The non-aqueous ink jet ink composition according to claim 1, further comprising:
one or more kinds of cyclic esters as the solvent, wherein
a total content of the one or more kinds of the cyclic esters contained in the ink composition is 5% by mass or more and 40% by mass or less.

6. The non-aqueous ink jet ink composition according to claim 1, further comprising:
a vinyl chloride resin.

7. The non-aqueous ink jet ink composition according to claim 1, wherein the content of the water is 0.1% by mass or more and 1% by mass or less.
